(19) United States
(12) Patent Application Publication
(10) Pub. No.: US 2024/0346920 A1
(43) Pub. Date: Oct. 17, 2024

(54) PASSAGE INFORMATION PROVIDING DEVICE, PASSAGE INFORMATION PROVIDING METHOD, AND PROGRAM STORAGE MEDIUM

(71) Applicant: NEC Corporation, Tokyo (JP)

(72) Inventors: Shigeki Shinoda, Tokyo (JP); Norifumi Yamazaki, Tokyo (JP); Hiroki Naoshima, Tokyo (JP); Satoshi Kusaka, Tokyo (JP); Shigenori Beppu, Tokyo (JP); Keita Suzuki, Tokyo (JP)

(73) Assignee: NEC Corporation, Tokyo (JP)

(21) Appl. No.: 18/751,725

(22) Filed: Jun. 24, 2024

Related U.S. Application Data
(63) Continuation of application No. 17/549,210, filed on Dec. 13, 2021.

(30) Foreign Application Priority Data
Dec. 22, 2020 (JP) 2020-212580

(51) Int. Cl. G08G 1/01; G01C 21/36; G06V 20/54

(52) U.S. Cl. CPC G08G 1/0133; G01C 21/3691; G06V 20/54; G08G 1/012; G08G 1/0129

(57) ABSTRACT

A passage information providing device acquires information regarding movement of people on a road as people flow information. The passage information providing device estimates whether the road is passable by using the people flow information that has been acquired. The passage information providing device outputs passage availability information indicating the estimated state of whether the road is passable.

This application is a continuation application of U.S. patent application Ser. No. 17/549,210 filed on Dec. 13, 2021, which is based upon and claims the benefit of priority from Japanese Patent Application No. 2020-212580, filed on Dec. 22, 2020, the disclosure of which is incorporated herein in its entirety by reference.

### TECHNICAL FIELD

The present invention relates to a technique for providing information on whether a vehicle can pass through a road.

### BACKGROUND ART

When there is a risk of a disaster or when a disaster occurs, safe evacuation of residents and prompt supply of relief supplies are desired.

However, when there is a portion where passage cannot be performed on a route to a destination such as an evacuation spot due to flooding or a depression of a road, a house fire, or the like, evacuees and supply vehicles need to bypass the unpassable portion where passage is disabled. If an evacuee or a supply vehicle goes to a destination by a route passing through the unpassable portion without knowing that there is the unpassable portion, the evacuee or the supply vehicle returns from the unpassable portion and searches for another route. In such a case, it takes a lot of time to arrive at the destination due to a loss of time due to returning or the like.

In order to set a route to a destination while avoiding a portion where passage is disabled due to an obstacle such as flooding of a road in order to reduce the loss of time due to such returning, it is desirable to obtain information on whether the road is passable in accordance with the actual situation.

Reference literature 1 (JP 2019-139462 A) discloses a technique for estimating a congestion state of a road using a mobile terminal device. Reference literature 2 (JP 2011-169856 A) discloses a technique of determining whether a vehicle can pass by motor travel by a secondary battery in a flooded area that may be flooded even if the area is flooded, and creating a route based on the determination result.

### SUMMARY

In order to solve the above problem, a passage information providing device according to the present invention includes, as one form thereof,
a processor configured to:
acquire information on movement of people on a road as people flow information;
estimate whether the road is passable using the people flow information that has been acquired; and
output passage availability information indicating an estimated state of whether the road is passable.

A passage information providing method according to the present invention includes, as one form thereof,
by a computer:
acquiring information on movement of people on a road as people flow information;
estimating whether the road is passable using the people flow information that has been acquired; and
outputting passage availability information indicating an estimated state of whether the road is passable. A program storage medium according to the present invention, as one form thereof, storing a computer program to cause a computer to execute processing of:
acquiring information on movement of people on a road as people flow information;
estimating whether the road is passable using the people flow information that has been acquired; and
outputting passage availability information indicating an estimated state of whether the road is passable.

### BRIEF DESCRIPTION OF THE DRAWINGS

Exemplary features and advantages of the present invention will become apparent from the following detailed description when taken with the accompanying drawings in which:

FIG. 1 is an image diagram illustrating an information providing system including a passage information providing device according to a first example embodiment;

FIG. 2 is a block diagram illustrating a configuration of the information providing system including the passage information providing device according to the first example embodiment;

FIG. 3 is a diagram illustrating people flow information based on position information on a mobile terminal device;

FIG. 4 is an image diagram illustrating passage availability information;

FIG. 5 is a diagram illustrating a recommended route;

FIG. 6 is a diagram illustrating a display example of a mobile terminal device in a case where a user inputs data of a distance range or a case that the user wants to avoid;

FIG. 7 is an image diagram illustrating a display form example of information provided by the passage information providing device;

FIG. 8 is a flowchart illustrating an example of information providing operation in the passage information providing device of the first example embodiment;

FIG. 9 is a block diagram illustrating a configuration of a passage information providing device according to a second example embodiment;

FIG. 10 is a block diagram illustrating a configuration of a passage information providing device according to another example embodiment; and

FIG. 11 is a flowchart illustrating an example of information providing operation of the passage information providing device illustrated in FIG. 10.

### EXAMPLE EMBODIMENT

Hereinafter, example embodiments according to the present invention will be described with reference to the drawings.

### First Example Embodiment

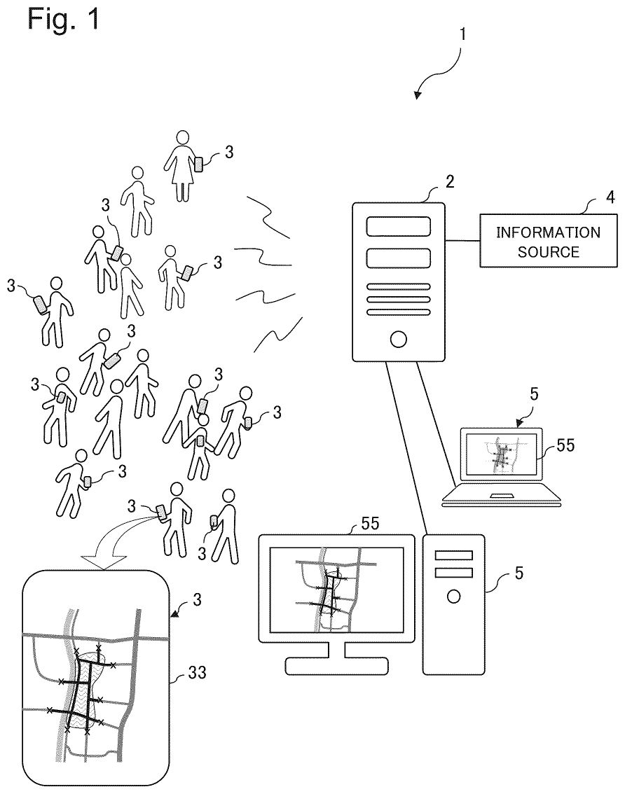

FIG. 1 is a diagram illustrating an image of an information providing system including a passage information providing device according to a first example embodiment of the present invention. An information providing system 1 is a system that estimates whether passage availability of a road on the basis of information on a flow of people to provide a user with passage availability information indicating the passage availability of the road. When a disaster occurs, the information providing system 1 can calculate an evacuation spot recommended for evacuation and a recommended route to the evacuation spot by using such passage availability information to provide recommended route information indicating the route. The information providing system 1 can calculate a recommended route to a destination to which the user goes by using the passage availability information, and provide recommended route information indicating the route.

As illustrated in FIG. 1, the information providing system 1 includes a passage information providing device 2. The passage information providing device 2 is a computer device such as a server, and is connected to a mobile terminal device 3 possessed by a user who uses the information providing system 1, via an information communication network. The mobile terminal device 3 has a function of transmitting position information indicating a location using a satellite positioning system such as a global positioning system (GPS). The mobile terminal device 3 includes a display device 33 that displays information, and can cause the display device 33 to display information received from the passage information providing device 2.

The passage information providing device 2 can also be connected to an information device 5 operable by a user who uses the information providing system 1 via an information communication network. The information device 5 is, for example, a personal computer (PC), has a communication function, and can cause the display device 55 to display information received from the passage information providing device 2 by the communication function.

The passage information providing device 2 is further connected to an information source 4 having information related to passage of a road via an information communication network. The information source 4 to which the passage information providing device 2 is connected is not particularly limited, and is appropriately connected to one or a plurality of information sources 4 that can output predetermined acquisition target information.

Specific examples of the acquisition target information acquired by the passage information providing device 2 from the information source 4 include traffic congestion information on a road, construction information indicating a construction portion of a road, information indicating contents of a notification to a fire department (also referred to as emergency notification information), weather information, and a captured image of a monitoring camera capturing an image of a road. Specific examples of the acquisition target information include social networking service (SNS) information posted using an SNS, a captured image in which a state outside the vehicle is captured by an in-vehicle camera, and sensor information such as an immersion sensor installed on a manhole lid and an outer wall of a house.

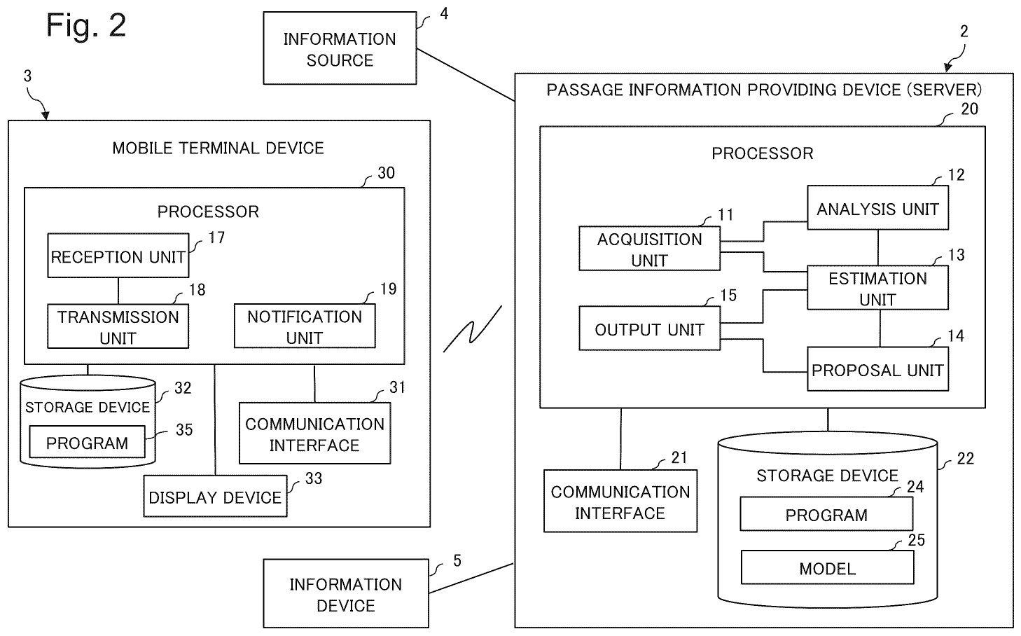

FIG. 2 is a block diagram illustrating a configuration example of the passage information providing device 2 and the mobile terminal device 3 connected to the passage information providing device 2.

The mobile terminal device 3 includes a processor 30, a communication interface 31, a storage device 32, and a display device 33. The display device 33 is a device having a configuration for displaying information such as a video and a character, and display operation thereof is controlled by the processor 30. The communication interface 31 is a device that communicates with a device having another communication function using an information communication network.

The storage device 32 includes a storage medium that stores data and a computer program (hereinafter, also referred to as a program) 35. There are a plurality of types of the storage device 32, and the type of the storage device 32 mounted on the mobile terminal device 3 is not limited, and the description of the configuration and operation of the storage device 32 is omitted here. A plurality of types of storage devices 32 may be provided in the mobile terminal device 3, and in this case, they are collectively referred to as a storage device 32. In the information providing system 1, the storage device 32 stores an application program (hereinafter, also referred to as an application APm) acquired from the passage information providing device 2 as one of the programs 35.

The processor 30 is a processor such as a central processing unit (CPU), and can have various functions based on the program 35 by reading and executing the program 35 stored in the storage device 32. Here, the processor 30 includes a reception unit 17, a transmission unit 18, and a notification unit 19 as functional units for using the information providing system 1 on the basis of the application APm supplied from the passage information providing device 2.

The reception unit 17 receives information necessary for specifying the location of the mobile terminal device 3 from a positioning system such as a GPS.

The transmission unit 18 transmits position information indicating the location of the mobile terminal device 3 based on the information received from the positioning system to the passage information providing device 2.

When the user inputs a command to search for an evacuation spot by operating an input device (not illustrated) provided in the mobile terminal device 3, the transmission unit 18 transmits the command as an evacuation spot search request to the passage information providing device 2.

When the user inputs information on a destination and a command to search for a route to the destination by operating the input device of the mobile terminal device 3, the transmission unit 18 transmits the command to the passage information providing device 2 together with the information on the destination as a route search request.

The notification unit 19 causes the display device 33 to display the information received from the passage information providing device 2 in a predetermined display form. The information received from the passage information providing device 2 includes the passage availability information indicating whether a road is passable as described above, recommended route information to an evacuation spot or a destination, and the like.

The passage information providing device 2 includes a processor 20, a communication interface 21, and a storage device 22. The communication interface 21 is a device that communicates with another communication device using an information communication network.

The storage device 22 includes a storage medium that stores data and a program 24. There are a plurality of types of storage devices such as a magnetic disk device and a semiconductor memory element, and there are a plurality of types of semiconductor memory elements such as a random access memory (RAM) and a read only memory (ROM). The type of the storage device 22 included in the passage information providing device 2 is not limited to one, and a plurality of types of storage devices 22 are often included in the passage information providing device 2. Here, the type and number of storage devices 22 provided in the passage information providing device 2 are not limited, and the description thereof will be omitted. When a plurality of types of storage devices 22 are provided in the passage information providing device 2, they are collectively referred to as a storage device 22.

As one of the programs 24 stored in the storage device 22, an application program (hereinafter, also referred to as an application APs) for causing the passage information providing device 2 to have a function for configuring the information providing system 1 is stored. The storage device 22 stores an application APm for causing the mobile terminal device 3 to have a function for using the information providing system 1 as another program 24. The application APm is provided to the mobile terminal device 3 in response to a request from the mobile terminal device 3, for example.

The storage device 22 stores a map indicating the position of a road or the position of a building, and data of a hazard map. The hazard map is a map displaying the positions of disaster-prevention related facilities such as disaster-stricken assumed areas, evacuation spots, and evacuation routes for the purpose of reducing damage caused by natural disasters and using the map for disaster prevention measures.

The storage device 22 further stores a model 25. The model 25 is a machine learning model based on artificial intelligence (AI) technology, and in the first example embodiment, the machine learning model as described below is stored in the storage device 22 as the model 25.

That is, one of the models 25 is a machine learning model (hereinafter, also referred to as a passage availability determination model) using map data and people flow information as described above as input data and passage availability information indicating a state of whether a road is passable as output data. The people flow information is information on a flow of people, and in the first example embodiment, the people flow information includes position information transmitted from the mobile terminal device 3.

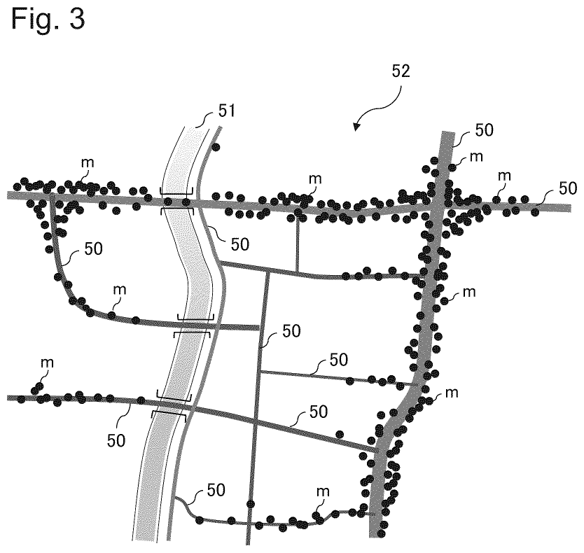

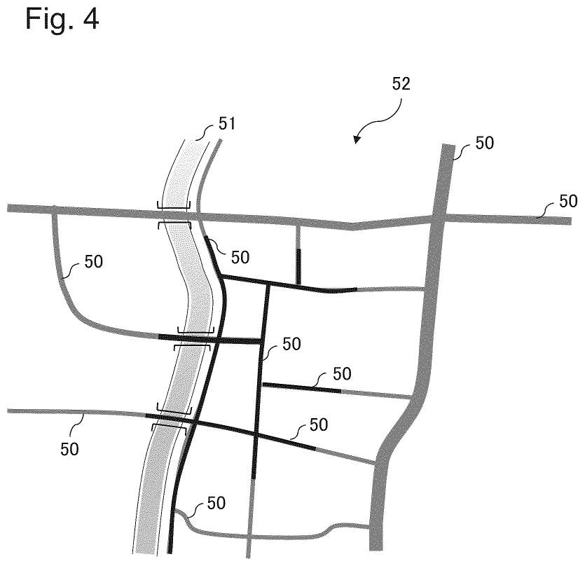

Describing using a specific example, when data of a map 52 representing a road 50, a river 51, and the like as illustrated in FIG. 3 and people flow information based on information on a location of the mobile terminal device 3 represented by a point m are input, the passage availability determination model outputs passage availability information as illustrated in FIG. 4. FIG. 4 is an image diagram illustrating an example of the passage availability information based on people flow information. In the example of FIG. 4, on the map 52, the state of whether the road 50 is passable is represented distinguishably by color coding, shading, or the like for each predetermined section of the road 50. In this example, a section where passage of a person is not detected on the basis of the people flow information is represented in a dark color as an unpassable portion where it is desirable to avoid passage since it is assumed that there is a possibility that there is some obstacle that hinders passage. A section where passage of a person is detected on the basis of the people flow information is represented in a lighter color than the color of the unpassable portion as a passable portion.

The passage availability determination model as described above is generated by machine learning of the relationship between the people flow information and the state of whether the road is passable relevant to the people flow information.

In a case where SNS information is acquired from the information source 4, the SNS information is analyzed by, for example, an AI technology. According to this analysis, when the SNS information includes information related to the passage state of the road, the information related to the passage state, information on the place, and information on the posted time are extracted from the SNS information. The information obtained in this manner may be used as people flow information. In a case where the SNS information is analyzed using the AI technology, the machine learning model used in the analysis is also stored in the storage device 22 as the model 25.

In a case where an image captured by a monitoring camera or an in-vehicle camera is acquired from the information source 4, the captured image is analyzed by, for example, an AI technology. By this analysis, when the captured image includes information related to the passage state of the road, the information related to the passage state and the information on the place are extracted from the captured image. Information on the capturing time associated with the information on the captured image is further extracted. The information obtained in this manner may be used as people flow information. In a case where the captured image is analyzed using the AI technology, the machine learning model used in the analysis is also stored in the storage device 22 as the model 25.

When the information obtained from the SNS information or the captured image is used as the people flow information, the passage availability determination model is generated by machine learning also including the people flow information based on the SNS information or the captured image.

Regarding the passage of the road 50, it is assumed that there may be a case where, even in the same road 50, whether a road is passable may be different depending on the moving means, such as a case where a pedestrian can pass through the road 50 but a vehicle cannot pass through the road, or a case where a tram can pass preferentially but a vehicle and a pedestrian are not allowed to pass through the road. Further, it is assumed that there may be a case where, even in the same road 50, whether a road is passable may be different depending on a difference in lanes, such as a case where passage in a lane on one side of lanes in opposite moving directions is available but passage in a lane on the other side is disabled due to an obstacle such as a construction or an accident. Further, it is assumed that there may be a case where, even if the vehicle passes through the same place on the map, whether a road is passable may be different depending on the type of the road, such as a case where passage in a general road on the ground is available but passage in a raised limited highway on the upper side of the general road is disabled due to the occurrence of an obstacle.

The moving means and the traveling lane of the user carrying the mobile terminal device 3 transmitting the position information and the type of the road on which the user is passing can be estimated using the moving speed, the moving direction, the moving manner, and the like of the position information (that is, the mobile terminal device 3). That is, it is possible to determine a moving means such as moving by walking or using a car or the like moving faster by using the moving speed such that the moving speed by walking is about 4 to 5 km/h and the moving speed by car is faster. In a case where a plurality of pieces of position information (mobile terminal devices 3) that are close to each other are moving in a similar manner (in other words, in a lump), it can be estimated that the mobile terminal devices 3 of the lump are moving on a tram. On a road having lanes in opposite moving directions, the lane in which the mobile terminal device 3 is moving can be determined by the moving direction of the position information (mobile terminal device 3). There is a case where the vehicle stops at a traffic light on a general road, whereas the vehicle does not stop at a traffic light on a limited highway. From this, since it is estimated that the movement speed of an automobile traveling on a limited highway is faster than that of a case of traveling on a general road due to the absence of traffic lights, it is possible to determine which road of a limited highway and a general road the automobile is traveling on by the movement speed.

The passage availability determination model may use, in addition to the people flow information (the position information on the mobile terminal device 3), the information on the moving speed and the moving direction of the people flow information as input data, and output the passage availability information for each moving means, moving lane, or moving road type. In this case, the passage availability determination model is generated by machine learning of a relationship between input data including information on a moving speed and a moving direction of the people flow information and a state of whether a road is passable for each moving means, a moving lane, and a moving road type. For example, the moving direction of the people flow information is obtained by tracking the people flow information (the position information on the mobile terminal device 3), and the moving speed is calculated on the basis of the moving distance and the moving time obtained by the tracking. The method for calculating the moving direction and the moving speed of the people flow information is not limited herein, and the description thereof will be omitted.

As the model 25, a machine learning model (hereinafter, also referred to as an evacuation spot search model) that outputs data of a position of an evacuation spot (hereinafter, also referred to as a recommended evacuation spot) recommended when evacuating from a location or a designated start point and a route (recommended route) to the evacuation spot is stored in the storage device 22. This evacuation spot search model uses, as input data, position information indicating a location of the mobile terminal device 3 (user) or a designated start point, information on a map including evacuation spot candidates for evacuation from the location, and passage availability information indicating a state of whether a road is passable. The input data also includes obstacle information on an obstacle that obstructs passage. Examples of the obstacle information include weather information, a hazard map, congestion information, construction information, and information on emergency notification contents to a fire department. The evacuation spot search model is generated by machine learning of the relationship between the input data as described above, and the position of the evacuation spot recommended for evacuation and the route to the evacuation spot.

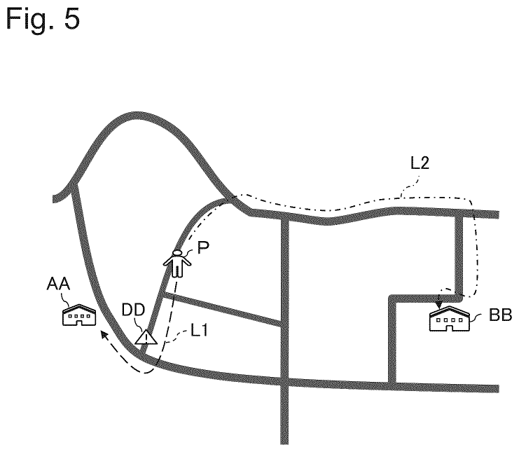

The evacuation spot search model thus generated outputs the recommended route as described below. For example, as illustrated in FIG. 5, it is assumed that the evacuation spot having the shortest distance from a location P is an evacuation spot AA, but there is a portion DD where it is assumed that avoiding passage is preferable on the basis of the passage availability information, in the middle of a route L1 having the shortest distance from the location P to the evacuation spot AA. Alternatively, it is assumed that there is a portion where it is assumed that heavy rain will occur on the basis of weather information as obstacle information during the movement along the route L1, and there is a possibility that a road will be flooded in the middle of the route L1 due to heavy rain. In such a case, it is necessary to go to the evacuation spot AA not by the route L1 of the shortest distance but by another detour route while avoiding the dangerous place, but the time until arrival at the evacuation spot AA becomes long. On the other hand, it is assumed that an evacuation spot BB is farther from the location than the evacuation spot AA, but there is no factor that hinders passage on the basis of the passage availability information or the obstacle information in the route L2 of the shortest distance to the evacuation spot BB. As a result, it is assumed that the time required from the location P to the evacuation spot BB is shorter than that in the case of detouring from the location P to the evacuation spot AA. In such a case, the evacuation spot search model presents the evacuation spot BB as the recommended evacuation spot, and outputs data of the route L2 as the recommended route to the evacuation spot BB.

As another model 25, a route search model is stored in the storage device 22. The route search model is a machine learning model that outputs data of a recommended route (hereinafter, referred to as a recommended route) from a location of the mobile terminal device 3 (user) or a designated start point to a destination to which the user goes. The route search model uses, as input data, position information indicating a location of the mobile terminal device 3 (user) or a designated start point, destination information, information on a map including a region from the location or the designated start point to the destination, passing availability information, and the above-described obstacle information. A route search model is generated by machine learning of a relationship between such input data and a recommended route from a location or a designated start point to a destination.

The number of recommended evacuation spots output from the evacuation spot search model and the number of recommended routes output from the route search model are not limited to one, and the evacuation spot search model and the route search model may be generated by machine learning so as to output a plurality of recommended evacuation spots and recommended routes in a state where priority information is attached. The evacuation spot search model and the route search model may be generated by machine learning so as to output one or a plurality of recommended evacuation spots and recommended routes each with a description. For example, the evacuation spot search model or the route search model may output the shortest route having the shortest distance and the most recommended route with a description of a difference therebetween. In this case, the description of the route output from the evacuation spot search model or the route search model is important information when the user selects a route, and supports the route selection of the user.

If the moving means of the user is different, such as a case where the user moves on foot and a case where the user moves by car, the recommended route may be different. In consideration of the above, the evacuation spot search model and the route search model may be generated by machine learning of a relationship between input data including data of moving means and the recommended evacuation spot and the recommended route. The evacuation spot search model and the route search model generated in this manner output the recommended evacuation spot and the recommended route relevant to the input moving means on the basis of the input data including the data of the moving means. Data of the moving means is input by the user operating the mobile terminal device 3 or the information device 5.

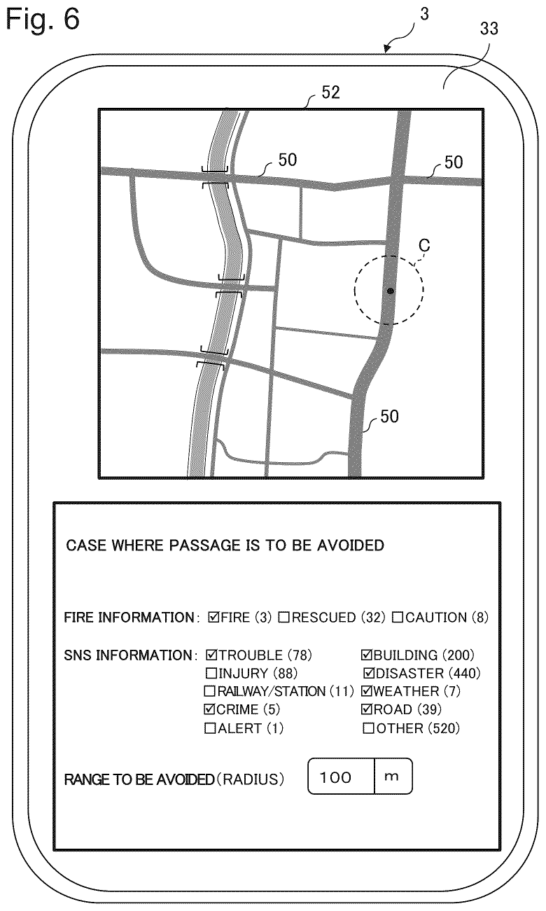

It is assumed that the distance range desired to be avoided from the obstacle point varies depending on the user, such as a case where a certain user wants to avoid a range of 100 meters from the obstacle point and a case where another user wants to avoid a range of 150 meters from the obstacle point. There are various cases where the user wants to avoid passage, such as a fire, rescue, or other warning case based on emergency notification information (fire information), and trouble, a crime, or an antisocial act based on SNS information. In consideration of the above, the evacuation spot search model and the route search model may be generated by machine learning of a relationship between input data including data of a distance range and a case that the user wants to avoid and the recommended evacuation spot and the recommended route. The evacuation spot search model and the route search model generated in this manner output the recommended evacuation spot and the recommended route in which the input distance range that the user wants to avoid is reflected on the basis of the input data including the data of the distance range that the user wants to avoid. Data of a distance range and a case that the user wants to avoid is input by the user operating the mobile terminal device 3 or the information device 5. FIG. 6 illustrates an example of a display screen of the display device 33 of the mobile terminal device 3 in a case where the user inputs data of a distance range or a case that the user wants to avoid. In the example of FIG. 6, the map 52 is displayed on the display device 33, and selection items of a case where passage has been avoided, a check field that displays whether the item is selected, and an input field (or selection field) of a distance range that the user wants to avoid are displayed. On the map 52 of the display device 33, a specific example of a range that the user wants to avoid according to the distance input in the input field of the distance range that the user wants to avoid is indicated by a dotted line C.

The processor 20 illustrated in FIG. 2 includes one or a plurality of processors such as a central processing unit (CPU) or a graphics processing unit (GPU), and can have various functions based on the program 24 by reading and executing the program 24 stored in the storage device 22. The processor 20 includes an acquisition unit 11, an analysis unit 12, an estimation unit 13, a proposal unit 14, and an output unit 15 as functional units on the basis of the application APs.

The acquisition unit 11 acquires position information as people flow information from the mobile terminal device 3 at predetermined timings (for example, at predetermined time intervals). The acquisition unit 11 further acquires information (for example, SNS information or congestion information) related to the passage state of the road from the predetermined information source 4 at predetermined timings (for example, at predetermined time intervals). The information acquired by the acquisition unit 11 is stored in the storage device 22. The acquired information includes time information such as the time of acquisition and the time of posting to the SNS.

The analysis unit 12 analyzes the people flow information acquired by the acquisition unit 11 to calculate a moving direction and a moving speed of a person (mobile terminal device 3). That is, the analysis unit 12 tracks the position information acquired from the same mobile terminal device 3, determines the moving direction of the mobile terminal device 3 on the basis of the tracking result, obtains the moving distance and the moving time, and further calculates the moving speed from the moving distance and the moving time.

When the acquisition unit 11 acquires the SNS information from the information source 4, the analysis unit 12 analyzes the SNS information to extract, from the SNS information, information on the passage state and information on the place, and information on the posted time as people flow information. As a method of extracting information from the SNS information in this manner, for example, there is a method using an AI technology. As described above, in a case where the SNS information is analyzed using the AI technology, the machine learning model used in the analysis is also stored in the storage device 22 as the model 25. The analysis unit 12 extracts the people flow information from the SNS information by analyzing the SNS information using the model 25. The information extracted from the SNS information is stored in the storage device 22 as the passage record.

When the acquisition unit 11 acquires an image captured by a monitoring camera or an in-vehicle camera from the information source 4, the analysis unit 12 analyzes the captured image to extract, from the captured image, information on the passage state and information on the place, and information on the capturing time as people flow information. As a method of extracting information from the captured image in this manner, for example, there is a method using an AI technology. As described above, in a case where the captured image is analyzed using the AI technology, the machine learning model used in the analysis is also stored in the storage device 22 as the model 25. The analysis unit 12 extracts the people flow information from the captured image by analyzing the captured image using the model 25. The information extracted from the captured image is stored in the storage device 22 as the passage record.

The estimation unit 13 estimates a state of whether a road is passable by using position information acquired as people flow information from the mobile terminal device 3 by the acquisition unit 11, a passage availability determination model which is the model 25 stored in the storage device 22, and map data. The state of whether a road is passable estimated by the estimation unit 13 is estimated for each predetermined section of the road.

When the moving direction and the moving speed of the person (mobile terminal device 3) are calculated by the analysis unit 12, the estimation unit 13 may estimate the state of whether the road is passable by also using the information on the calculated moving direction and moving speed. When the SNS information is analyzed by the analysis unit 12, the estimation unit 13 may estimate the state of whether the road is passable by also using the people flow information obtained by the analysis of the SNS information. When the captured image is analyzed by the analysis unit 12, the estimation unit 13 may estimate the state of whether the road is passable by also using the people flow information obtained by the analysis of the captured image.

The information indicating the state of whether the road is passable thus estimated is accumulated in the storage device 22 as passage availability information. The passage availability information is associated with generated time information.

The estimation unit 13 performs the estimation of the state of whether the road is passable as described above at every predetermined update timing (for example, every predetermined update time interval (for example, every 3 minutes)). In other words, the estimation unit 13 automatically updates the passage availability information.

When receiving the evacuation spot search request and information on the location or the position of the start point designated by the user from the mobile terminal device 3 or the information device 5, the proposal unit 14 generates proposal information indicating the recommended evacuation spot and the recommended route to the recommended evacuation spot. For example, the evacuation spot search model of the storage device 22 is used to generate the proposal information. In the generation of the proposal information, in addition to the information on the location or the position of the start point designated by the user, information on a map including evacuation spot candidates for evacuating from the location, passage availability information indicating a state of whether a road is passable, and obstacle information regarding obstacles that hinder passing are used.

Depending on the evacuation spot search model to be used, the proposal information may include information on a plurality of prioritized recommended evacuation spots and recommended routes to the recommended evacuation spots. A plurality of recommended routes may be indicated for one recommended evacuation spot. The proposal unit 14 may propose proposal information indicating the recommended evacuation spot and the recommended route according to the moving means (walking, car, or the like). In this case, information indicating the moving means is input by operation by the user of the mobile terminal device 3 or the information device 5.

When receiving the route search request, position information on the destination, and information on the location or the position of the start point designated by the user from the mobile terminal device 3 or the information device 5, the proposal unit 14 generates proposal information indicating the recommended route to the destination. For example, the route search model of the storage device 22 is used to generate the proposal information. In the generation of the proposal information, in addition to the information on the location or the position of the start point designated by the user, information on a map including the destination from the location, passage availability information indicating a state of whether a road is passable, and obstacle information regarding obstacles that hinder passing are used.

Depending on the route search model to be used, the proposal information may include information on a plurality of prioritized recommended routes. The proposal unit 14 may generate proposal information indicating the recommended route according to the moving means (walking, car, or the like). In this case, information indicating the moving means is input by operation by the user of the mobile terminal device 3 or the information device 5.

The output unit 15 transmits the latest passage availability information by the estimation unit 13 to the mobile terminal device 3 and the information device 5. Examples of the transmission timing include every time the estimation unit 13 generates the passage availability information, every time interval set by the user of the mobile terminal device 3, and when a command for requesting update of information is received from the mobile terminal device 3.

When the passage information providing device 2 acquires the SNS information, the output unit 15 may transmit people flow information (information related to a passage state and information on the place, and information on posted time) which is an analysis result of the SNS information by the analysis unit 12 to the mobile terminal device 3 or the information device 5. When the passage information providing device 2 acquires the captured image, the output unit 15 may transmit people flow information (information related to a passage state and information on the place, and information on capturing time) which is an analysis result of the captured image by the analysis unit 12 to the mobile terminal device 3 or the information device 5. Such people flow information based on the SNS information and the captured image is transmitted to the mobile terminal device 3 and the information device 5 in association with, for example, the passage availability information. The output unit 15 may transmit the captured image to the mobile terminal device 3 or the information device 5.

The output unit 15 may transmit the obstacle information acquired from the information source 4 and used to generate the passage availability information to the mobile terminal device 3 and the information device 5 in association with the passage availability information.

When the proposal information is generated by the proposal unit 14, the output unit 15 returns the generated proposal information to the mobile terminal device 3 or the information device 5 that has transmitted the evacuation spot search request or the route search request that has triggered the generation of the proposal information. As described above, when transmitting (returning) the proposal information, the output unit 15 may also transmit the latest passage availability information to the mobile terminal device 3.

As described above, when the information output from the passage information providing device 2 by the output unit 15 is received by the mobile terminal device 3 or the information device 5, the received information is displayed on the display device 33, 55 in a predetermined display mode by the control function of the notification unit 19 of the mobile terminal device 3 or the information device 5.

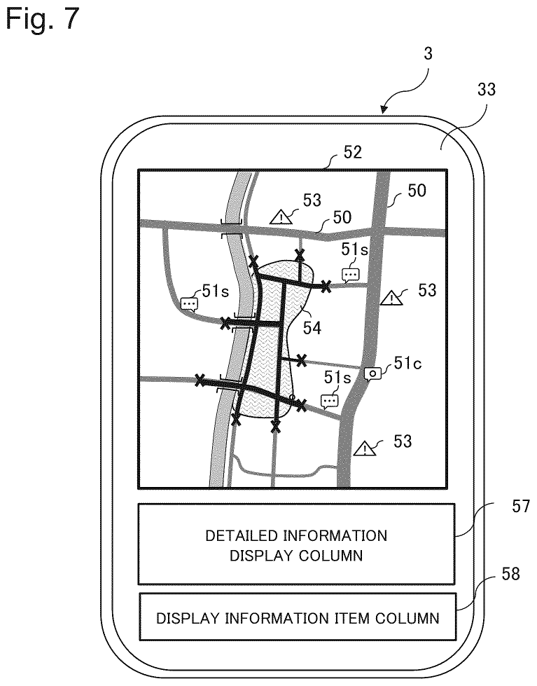

FIG. 7 is a display example of passage availability information on the display device 33 of the mobile terminal device 3. In the example of FIG. 7, the map 52 is displayed on the display device 33, and the state of whether the road 50 is passable displayed on the map 52 is distinguishably displayed by color coding, shading, and the like on the basis of the passage availability information. On the map 52 of the display device 33, marks 51s, 51c representing places relevant to information related to a passage state obtained from SNS information or a captured image are displayed on the basis of the people flow information received from the passage information providing device 2. On the map 52 of the display device 33, a mark 53 or an image 54 indicating the occurrence of an obstacle is displayed at an obstacle occurrence location based on the obstacle information. In the example of FIG. 7, the image 54 indicating the occurrence of an obstacle is an image indicating a submerged region.

In the display device 33, detailed information such as passage availability information, people flow information (SNS information or a captured image), and obstacle information is displayed in a detailed information display column 57 by characters. For example, when the marks 51s, 51c, 53 and the image 54 displayed on the map 52 are designated (clicked) by the user, details of information related to the designated marks 51s, 51c, 53 and the image 54 are displayed in the detailed information display column 57. When the road 50 displayed on the map 52 is designated (clicked) by the user, the acquisition time of the passage record in the designated road section may be displayed in the detailed information display column 57.

Whether to display the color coding, marks 51s, 51c, 53, images 54, and the like of the road relevant to the passage availability information, the people flow information (SNS information or a captured image), and the obstacle information can be selected, and item names of the selectable information are displayed in a list in the display information item column 58, for example. By, for example, checking or unchecking the displayed item name, whether to display information (color coding, marks 51s, 51c, 53, image 54, and the like of the road) on the map 52 is switched.

When the display device 33 of the mobile terminal device 3 displays the proposal information indicating the recommended evacuation spot and the recommended route, for example, the recommended evacuation spot and the recommended route are displayed on the map 52. For example, in the detailed information display column 57 of the display device 33, a description of the position of the recommended evacuation spot and the recommended route is displayed by characters. In the detailed information display column 57, recommended reasons (explanations) for the recommended evacuation spot and the recommended route may be displayed by characters. When the reason (explanation) is given in this manner, the evacuation spot search model or the route search model is a model that has learned to also output such a reason (explanation).

When the mobile terminal device 3 receives a captured image of a monitoring camera or an in-vehicle camera, the captured image may be displayed on the display device 33.

The information device 5 similarly displays information provided from the passage information providing device 2.

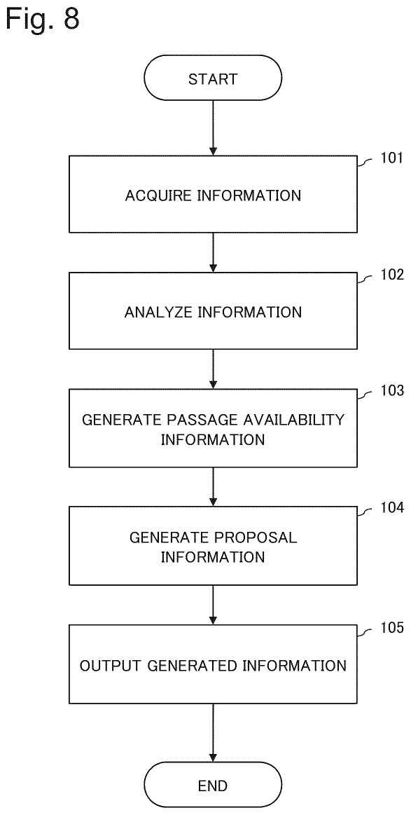

The information providing system 1 including the passage information providing device 2 of the first example embodiment is configured as described above. An example of information providing operation in the passage information providing device 2 will be described below with reference to FIG. 8. FIG. 8 is a flowchart illustrating an example of information providing operation in the passage information providing device 2.

For example, first, the acquisition unit 11 of the passage information providing device 2 acquires position information from the mobile terminal device 3 as people flow information, and acquires information on a predetermined acquisition target from the information source 4 (step 101 in FIG. 8). Thereafter, the analysis unit 12 analyzes the position information on the mobile terminal device 3 to calculate the moving speed and the moving direction of the people flow information (the position information on the mobile terminal device 3) (step 102). The analysis unit 12 also extracts people flow information from the SNS information or captured image by analyzing the SNS information or captured image using the model 25 as necessary.

Thereafter, the estimation unit 13 estimates the state of whether the road is passable using the people flow information, the model 25, and the like (step 103). In a case where the evacuation spot search request or the route search request has been received, the proposal unit 14 generates proposal information indicating the recommended evacuation spot or the recommended route (step 104).

Thereafter, the output unit 15 outputs predetermined information to be transmitted, such as generated passage availability information and proposal information, people flow information obtained by analyzing the SNS information or captured image, and acquired obstacle information, to the mobile terminal device 3 and the information device 5 (step 105).

The passage information providing device 2 performs a series of information providing operations as described above, and provides the mobile terminal device 3 and the information device 5 with road passage availability information, proposal information indicating a recommended evacuation spot and a recommended route, and the like. Such information providing operation is performed, for example, at preset time intervals, and thereby, the passage availability information and the proposal information displayed on the mobile terminal device 3 and the information device 5 are automatically updated.

Since the passage information providing device 2 of the first example embodiment is configured as described above, it is possible to obtain an effect that it is possible to provide information suitable for actual conditions regarding whether a road is passable. As a result, the probability that the user provided with the information by the passage information providing device 2 will go to the evacuation spot or the destination without getting into a trouble is increased, and safe evacuation and speeding up the supply of relief supplies are achieved.

### Second Example Embodiment

A second example embodiment according to the present invention will be described below. In the description of the second example embodiment, the same reference numerals are given to the same name portions as the components constituting the information providing system in the first example embodiment, and redundant description of the common portions will be omitted.

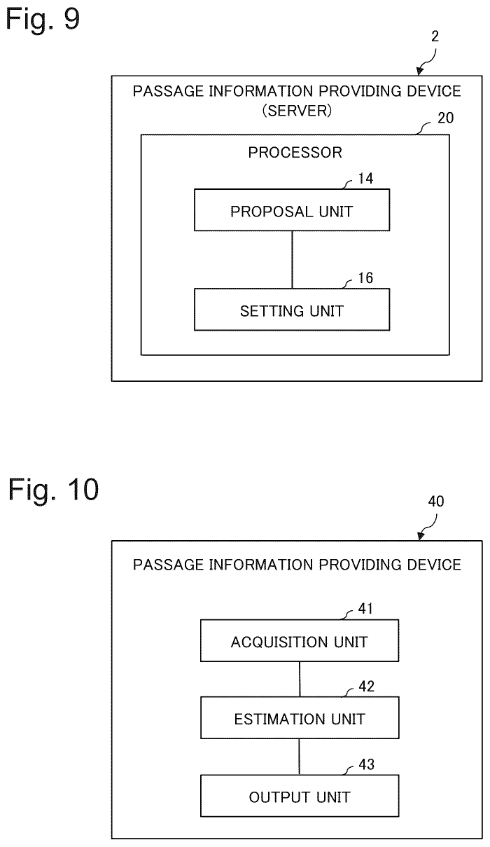

The passage information providing device 2 of the second example embodiment includes a setting unit 16 as illustrated in FIG. 9 in addition to the configuration of the first example embodiment. In FIG. 9, only main portions of the passage information providing device 2 used in the description of the second example embodiment are illustrated, and illustration of other components is omitted.

The setting unit 16 uses the passage record of the road 50 based on the people flow information to set an index indicating the possibility of passing through the section of the road as a passage index for each preset section of the road 50. A method of setting the passage index is not limited, but for example, it is conceivable to use an AI technology.

The proposal unit 14 generates the proposal information by using the passage index in addition to the passage availability information, the obstacle information, the information on the location of the mobile terminal device 3 (user) or the position of the start point designated by the user, and the position information on the facility as the evacuation spot or the position information on the destination.

For example, it is assumed that a section where passage is estimated to be disabled is included in any of a plurality of routes to the evacuation spot. When referring to the passage index set in the section where passage is estimated to be disabled, there is a case where a section where passage is estimated to be disabled is merely a section where the location of the mobile terminal device 3 is not confirmed, and it is assumed that the passage is available. Originally, a route avoiding a section where passage is estimated to be disabled should be set as a recommended route, but in a case where there is no other evacuation route, the proposal unit 14 generates proposal information indicating the recommended route by setting, as the recommended route, a route passing through a section where there is a possibility that passage is available on the basis of the passage index.

Since the passage information providing device 2 of the second example embodiment has the same configuration as that of the first example embodiment, a similar effect to that of the first example embodiment can be obtained. Since the passage information providing device 2 of the second example embodiment includes the setting unit 16, it is possible to provide information on a recommended route in consideration of a past passage record.

### OTHER EXAMPLE EMBODIMENTS

The present invention is not limited to the first and second example embodiments, and various embodiments can be adopted. For example, in the first and second example embodiments, the position information on the mobile terminal device 3 acquired by the passage information providing device 2 is based on the operation of the mobile terminal device 3 based on the application APm supplied from the passage information providing device 2. In addition to the position information transmitted from the mobile terminal device 3, the passage information providing device 2 may acquire the position information on the mobile terminal device from a computer device of a telecommunication carrier as one of the information sources 4.

It is considered that it is preferable to limit a period in which the SNS information is to be considered in the route search. Therefore, a period from a posted time using the SNS information may be determined in advance as the information valid period, and the information on the information valid period may be associated with the people flow information extracted by the analysis unit 12 from the SNS information. In a case where the people flow information associated with the information valid period is used for generation of the passage availability information by the estimation unit 13 or generation of the recommended evacuation spot or the recommended route by the proposal unit 14, the people flow information within the information valid period is used for generation of the passage availability information, the recommended evacuation spot, or the recommended route. Since each piece of the SNS information is information such as a point, a range (distance) to detour in the passage based on the information may be appropriately set by the user of the mobile terminal device 3 using the data input screen as illustrated in FIG. 6 or by the operator of the passage information providing device 2. Alternatively, the detour range (distance) may be determined by AI technology. In this case, a model generated by machine learning of the relationship between the posted content of the SNS information and the detour range (distance) is used.

For example, FIG. 10 is a block diagram illustrating a minimum configuration example of the passage information providing device according to the present invention. A passage information providing device 40 is, for example, a computer device, and includes an acquisition unit 41, an estimation unit 42, and an output unit 43 as functional units. The acquisition unit 41 acquires information regarding movement of people on a road as people flow information. The estimation unit 42 estimates whether a road is passable by using the acquired people flow information. The output unit 43 outputs passage availability information indicating the estimated state of whether the road is passable. The functions of the acquisition unit 41, the estimation unit 42, and the output unit 43 are achieved, for example, by a processor executing a computer program similarly to the first and second example embodiments.

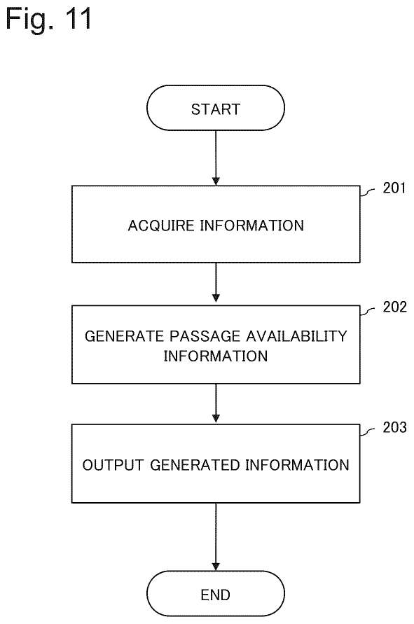

Such a passage information providing device 40 executes operation related to information provision as below, for example. FIG. 11 is a flowchart illustrating an example of information providing operation in the passage information providing device 40.

For example, the acquisition unit 41 acquires information regarding movement of people on a road as people flow information (step 201). Thereafter, the estimation unit 42 estimates whether a road is passable by using the acquired people flow information (step 202). Thereafter, the output unit 43 outputs passage availability information indicating the estimated state of whether the road is passable (step 203).

Since the passage information providing device 40 as described above uses people flow information, it is possible to obtain an effect that it is possible to provide information suitable for actual conditions regarding passage availability of a road.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A passage information providing device comprising
a processor configured to:
acquire information regarding movement of people on a road as people flow information;
estimate whether the road is passable by using the people flow information that has been acquired; and
output passage availability information indicating a state of whether the road is passable that has been estimated.

2. The passage information providing device according to claim 1, wherein the processor is further configured to generate recommended route information based on the state of whether the road is passable that has been estimated, information on a location of a user, and position information on the facility as the evacuation spot, the recommended route information indicating a recommended route to a facility as an evacuation spot where the user evacuates.

3. The passage information providing device according to claim 1, wherein the processor is further configured to generate recommended route information based on the state of whether the road is passable that has been estimated, information on a location of a user, and position information on a destination to which the user goes, the recommended route information indicating a recommended route from the location of the user to the destination.

4. The passage information providing device according to claim 2, wherein the processor is further configured to, using a passage record of the road based on the people flow information, set a passage index, the passage index indicating a possibility that each preset section of the road is passable,
the processor generates the recommended route information indicating a recommended route to the facility as the evacuation spot or a destination by using the passage index in addition to the state of whether the road is passable, the information on the location of the user, and the position information on the facility as the evacuation spot or position information on the destination, and
even in a section that is not estimated to be passable based on the people flow information, there is the section incorporated into the recommended route based on the passage index.

5. The passage information providing device according to claim 2, wherein the processor acquires at least one of weather information, road congestion information, emergency notification information, and sensor information as state information, and
the processor generates the recommended route information by using the state information in addition to the people flow information.

6. The passage information providing device according to claim 1, wherein the people flow information includes at least position information on a mobile terminal device among the position information on the mobile terminal device, a captured image in which a state of the road is captured, and social networking service (SNS) information posted using an SNS.

7. The passage information providing device according to claim 6, wherein the processor is further configured to determine a type of a moving means of a person who possesses the mobile terminal device based on a moving state of the position information on the mobile terminal device.

8. A passage information providing method comprising,
by a computer:
acquiring information on movement of people on a road as people flow information;
estimating whether the road is passable using the people flow information that has been acquired; and
outputting passage availability information indicating an estimated state of whether the road is passable.

9. A non-transitory program storage medium storing a computer program to cause a computer to execute:
acquiring information on movement of people on a road as people flow information;
estimating whether the road is passable using the people flow information that has been acquired; and
outputting passage availability information indicating an estimated state of whether the road is passable.
